(19) United States
(12) Patent Application Publication
(10) Pub. No.: US 2011/0251973 A1
(43) Pub. Date: Oct. 13, 2011

(54) DERIVING STATEMENT FROM PRODUCT OR SERVICE REVIEWS

(75) Inventors: Yanqing Chen, Bellevue, WA (US); Jason S. Wodicka, Seattle, WA (US); Jonathan R. Hart, Kirkland, WA (US)

(73) Assignee: MICROSOFT CORPORATION, Redmond, WA (US)

(21) Appl. No.: 12/756,994

(22) Filed: Apr. 8, 2010

(51) Int. Cl. G06Q 99/00

(52) U.S. Cl. 705/347

(57) ABSTRACT

Reviews of products may be analyzed, and statements about the products may be made based on the analysis. Non-professional reviews (e.g., reviews of products written by ordinary consumers of those products) are often difficult to interpret, because different reviewers may apply different standards. When a large number of reviews are available, the reviews can be analyzed statistically to make comparative statements about the products or services reviewed. Sentiments expressed in the reviews may be assigned numerical values. These numerical values for specific products, or classes of products, may be analyzed statistically to determine how the sentiments about a specific product compare with the sentiments about a larger class of products. Using this analysis, a statement can be made, such as, “This television has very good picture quality compared with other televisions of the same price.”

### BACKGROUND

One type of information that people commonly seek on the Internet is a review of a product or service. There are some web sites whose main function is to allow consumers to review products. In other cases, web sites provide reviews as part of some other service. For example, web sites of large commercial retails often allow customers to write reviews of the products that are sold on the sites. Sites that facilitate the selling of products by small sellers (e.g., eBay, Amazon marketplace, etc.) often allow users to review the experience they have had with particular sellers.

While some sites employ professional experts to perform formal, technical reviews of products and services, many reviews are provided by ordinary consumers. While consumer feedback can be valuable, it is often difficult to interpret. Different people may have different expectations. Thus, when reading a review, it is often difficult to know what the words in the review mean. For example, two people who review a television both describe the picture quality of the television as “good”, but “good” might mean different things to these two people. Moreover, reviewers are often asked to rate a product or service numerically on one or more dimensions (e.g., “rate the picture quality of this television on a scale of one to five”), but people often do not agree on how the numbers are to be assigned. Two people might be equally impressed by the picture quality of a television, but one person might rate the picture a three while the other rates it a four.

If one reads many ratings of the same or similar products, one might gain a comprehensive picture of the product space and how the various products differ from each other. But reading a large enough number of reviews to get such a comprehensive picture is time consuming.

### SUMMARY

Reviews may be analyzed to determine the relationship between reviews of a product and facts that are known about the product. Using this analysis, statements can be made about how a given product compares with other products that share the same factual features.

For example, suppose that the favorability of a narrative review of a television can be measured numerically (e.g., reviews that say “okay” get a five on a scale of one to ten, while reviews that say “horrible” get a one). Once such numerical values are assigned to reviews, it is possible to find the average favorability rating of a particular product or class of products. So, suppose that there are three brands of televisions—A, B, and C—in the $1400-1500 price range, and the average favorability of a review of any of these brands is four on a scale of one to ten. Suppose further than the average favorability of reviews for brand A is six. Then, it is possible to make the statement that brand A is viewed more favorably than other brands of television in the same price range. This statement may be over interest to a consumer when making a purchase decision, since it summarizes what reviews say about brand A's televisions, and those reviews compare with reviews of other televisions in the same price range. Techniques described herein may be used to generate this kind of statement.

In order to provide such an analysis, textual reviews are analyzed to determine what sentiments they express about a product. Information may be extracted in the form of numerical ratings. For example, reviews might be analyzed to determine what they say about three different aspects of a television: picture, sound, and construction quality. By looking for certain key words and phrases (e.g., “picture is good/amazing/terrific/bad/horrible/barely visible”), it is possible to assess on a numerical scale what a reviewer is saying about various aspects of a television. For example, if a review describes the picture as “good”, the review may be interpreted as rating the picture quality a six, while a review that describes a picture as “amazing” might be interpreted as rating the picture quality an eight. Moreover, textual analysis can be performed on a manufacturer's specifications of a television, which contains basic factual information such as the suggested retail price, the screen size, the screen resolution, etc., and each type of fact can be assigned a number. The result of this analysis is a set of variables. These variables can be analyzed statistically to determine relationships between the variables. For example, one can analyze the average picture quality for 46-inch televisions, or the average sound quality for televisions in the $1400-1500 price range.

Once the relationship between two variables is known, it is possible to make statements about how a specific product fares against other products in the same class. For example, one can say, “The brand-A 46-inch television has a higher picture quality, but a lower sound quality, than other 46-inch televisions,” or “the brand-B television has high sound quality compared with televisions of the same price.” In this sense, a statement that compares the reviews of a specific class of product or service (e.g., a specific model number of television) to some more general class of product or service (e.g., all televisions of a specific screen size) may serve as a kind of auto-generated summary of an existing set of reviews.

In the description herein, products are used as an example of things that can be reviewed, although the techniques described herein can apply to anything that can be reviewed—e.g., products, services, etc.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example set of components in which a review of a product or service may be created based on other information.

FIG. 2 is a block diagram of an example relationship between two variables, and an example statistical analysis that may be performed on those variables.

FIG. 3 is a block diagram of an example user interface that contains statements about a product or service.

FIG. 4 is a flow diagram of an example process in which reviews may be analyzed, and in which statements about a product or service may be made.

FIG. 5 is a block diagram of example components that may be used in connection with implementations of the subject matter described herein.

### DETAILED DESCRIPTION

People often look to consumer reviews when they want to investigate a product or service. The Internet has made it very easy to write and read reviews. Thus, reviews can be found at various places online. For example, commercial retail web sites often allow users to write reviews of products they have purchased. These web sites often display the consumer reviews with the product so that consumers who are considering buying the same product can find out what others think of the product. Online marketplaces (eBay, Amazon marketplace, etc.) often give buyers the chance to write reviews of sellers.

While consumer reviews are readily available for a wide variety of products and services, these reviews are often difficult to interpret. Traditionally, product and service reviews were created by professional experts. A consumer magazine can employ a team of engineers to put a product through rigorous technical tests. Auto clubs can engage experienced travelers to stay at hotels and rate the service that they receive. These types of reviews are reliable and convey much information because they subject the product or service that is being reviewed to uniform standards that can be well-publicized. By contrast, a typical consumer rates only a few products, and different consumers may have very different personal standards when they review products. For example, two different consumers may have the same subjective impression of the picture quality of a television, but one consumer might have higher expectations than the other. Thus, one consumer might describe the picture quality as “average,” while the other might describe the picture quality as “amazing.” Moreover, consumers tend to encounter fewer products than professional reviewers, so the fact that one particular consumer thinks the television he bought has “fantastic” sound quality may not be particularly informative or reliable, since that consumer may not know much about the general level of quality that one can expect from televisions.

While an individual consumer review may provide information that is difficult to interpret, examining a large number of consumer reviews tends to provide a reliable picture of what consumers think of a product or service. The fact that one consumer thinks the brand-A 46-inch television has a great picture does not, in itself, provide much information. However, the fact that one thousand consumers have given the brand-A 46-inch television reviews that range from good to excellent suggests that the television may be a high quality television. And if there are there are an additional one thousand reviews that rate the brand-B and brand-C 46-inch televisions “poor”, then the high quality ratings of brand-A look all the more impressive by comparison. In other words, when reviews are provided by consumers who apply a wide range of standards and have relatively little experience with the types of products they are rating, the reliability of these reviews comes from two sources: large numbers, and a reference point against which the statements of the consumers can be compared. Considering a large number of reviews decreases the chance that one's impression will be influenced by an aberrational review. And comparing a large number of reviews of brand-A's product with a large number of reviews of similar products allows the similar products to serve as a reference point against which the reviews of brand A's product can be interpreted.

However, most consumers do not have time to canvass a large number of reviews. Thus, the problem of interpreting consumer reviews amounts to marshalling and modeling a large amount of information, much of which is contained in free-form, narrative textual review. The subject matter described herein provides a way to marshal and interpret reviews.

In order to analyze reviews, two types of information are mined: first, basic facts about the product or service being reviewed, and, second, reviewers' impressions of the product or service as expressed in the narrative part of the review. First, basic facts about the products and services are mined from information that is made available by the manufacturer of a product or the provider of a service. For example, if company A makes televisions, it will likely provide basic information about each model of television—e.g., the suggested retail price, the screen size, the screen resolution, the display technology (e.g., plasma or liquid crystal), the number of input connectors, etc. As another example, a hotel company will likely provide basic information about its hotel rooms—e.g., location of the hotel, the price range for different types of room, the sizes of the rooms, the number of restaurants in the hotel, etc. This type of information can be mined from online or print material using text analysis techniques, such as entity extraction.

Second, the reviews themselves are mined to identify what reviewers have said about the product or service they are reviewing. That is, the narrative part of the review may be analyzed to determine what sentiments it appears to express about particular aspects of the product or service being reviewed. A television review that says “picture quality is poor” is expressing the reviewer's sentiment about a product or service, and this sentiment can be extracted from the narrative part of a review.

These two types of information—the basic facts about a product, and the reviews of that product—are used in the following manner. The basic facts about products and services are used to create categories that can be meaningfully compared. For example, it makes sense to compare two 46-inch televisions with 1080p displays. But it makes little sense to compare a 20-inch standard definition cathode ray television with a 65-inch high definition plasma television. In some cases it makes sense to compare any two televisions of the same size and screen resolution; in other cases, it makes sense to compare televisions that have similar prices. Similarly, it makes sense to compare two luxury hotels in midtown Manhattan, but it makes little sense to compare a boutique hotel in Seattle with a roadside motel in Winnemucca, Nev. What type of product or service is being offered can be determined from the basic information that the manufacturer or service provider makes available. This information can be used to create categories of products or services, so that products or services in those categories can be meaningfully compared. That is, if one wants to compare televisions of similar price, then one can determine which televisions are in the same price category using the suggested retail price information provided by the manufacturer.

The reviews themselves are mined to convert free-form narrative statements about a product into a set of metrics. For example, suppose that ratings of televisions come down to ratings of three attributes: picture quality, sound quality, and construction quality. One can examine a narrative review of a particular television to see what the reviewer has said about these three attributes, and can assign a numerical rating to each attribute. Thus, if a reviewer says, “The Minisonic 46-inch 1080p television has a stupendous picture,” one might interpret this statement as saying that the picture quality rates nine on a scale of one to ten. If the review later says that the television “had a very flat sound,” one might interpret this statement as saying that the sound quality rates three on a scale of one to ten. There are various techniques used to perform this type of textual analysis. In one example, an analyzer can maintain a list of descriptive words and phrases with point values assigned, and can look for these words and phrases in proximity to other words that indicate what feature of the television is being described. For example, if the word “flat” appears adjacent to “sound”, then it is likely that the person is saying the sound is flat. If the list of words indicates that “flat” is associated with poor sound quality, then the sentiment that the review is expressing about sound quality can be assigned a low numerical value—e.g., three on a scale of one to ten—(indicating an unfavorable review).

Once information has been mined from the reviews, it is possible to calculate statistics about the reviews. For example, one could calculate the average picture quality of all 46-inch televisions, or the average sound quality of all 46-inch televisions in the $1400-1500 price range. Or, one could plot the relationship between picture quality and price. Additionally, once this type of information has been calculated for a meaningful class of televisions, it is possible to compare a specific television with all televisions in that class. Thus, if the average picture rating for 46-inch televisions in the $1400-1500 price range is four, but the average rating for the Minisonic 46-inch plasma screen television is a seven, then it is possible to make a statement such as, “The Minisonic 46-inch plasma screen television has a high picture quality compared with other televisions of its size and price.” This statement brings together a large amount of information from reviews. It quantifies what people have said about televisions of a particular size and price in general, also distinguishes what people say about one particular 46-inch television in the $1400-1500 price range from what people have said generally about other versions of that size/price of television. This type of statement may be viewed by consumers as being more authoritative than one reviewer's isolated opinion. Additionally, this type of statement can be produced for less money than a professional expert review of a product, thereby making it economically feasible for online information aggregation services to provide this type of statement.

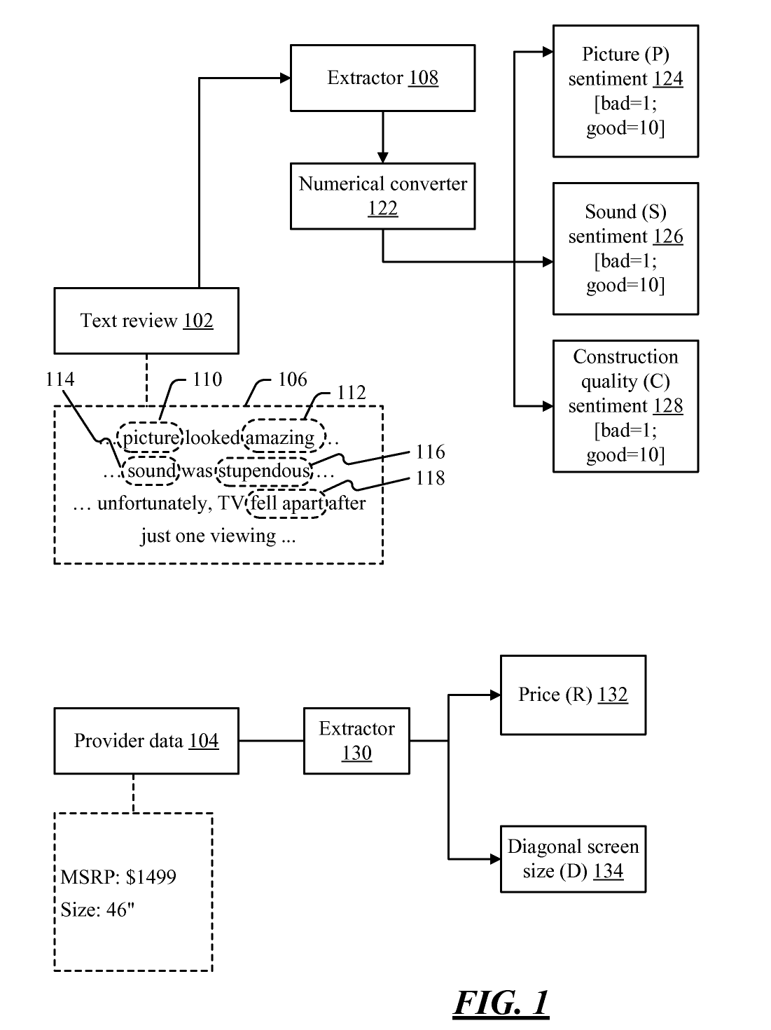

Turning now to the drawings, FIG. 1 shows an example set of components in which a review of a product or service may be created. As noted above, reviews may comprise statements such as “The brand-A television has very good picture for its price,” and thus the basis for this statements is a set of reviews for televisions, and basic data about the prices of specific televisions. Thus, FIG. 1 shows a text review 102, and provider data 104. There may be several reviews and several pieces of provider data; however, for simplicity of illustration, FIG. 1 shows only a single review and a single piece of provider data. Text information contains a narrative 106 that makes various statements about a particular brand of television—e.g., a Minisonic 46-inch 1080p HDTV. For example, narrative 106 states that the “picture looked amazing,” and that the “sound was stupendous.” A textual analysis may be performed on this narrative in order to attempt to quantify the information contained therein. A component such as extractor 108 may look for certain terms in narrative 106, and may attempt to interpret those terms. For example, extractor 108 may detect that the word “picture” (box 110) appears near the word “amazing” (box 112), and may determine that the presence of these words in close proximity to each other in narrative 106 indicates that the writer of narrative 106 is making a positive statement about the picture quality. Similarly, extractor 108 may detect that the word “sound” (box 114) appears near the word “stupendous” (box 116), and may therefore detect that the writer of narrative 106 is making a positive statement about the sound quality.

Extractor 108 may maintain a list of words that it associates with positive or negative statements. That list may also quantify the magnitude of how positive or negative particular words are. For example, “amazing” and “stupendous” may be considered words that indicate a very high level of satisfaction, while “good” might indicate a sentiment that is positive, but not as strongly positive as the words “amazing” and “stupendous.” The word “bad” might be interpreted as a mildly negative sentiment, and the word “awful” might be interpreted as a strongly negative sentiment. Numerical values could be assigned to these statements according—e.g., one for “awful”, nine for “amazing.”

The depth of the text analysis may depend on the underlying data about what the words and phrases in a review mean. For example, extractor 108 might maintain a database that contains the meanings of general adjectival characterizations like “amazing” and “bad”, but could also include very specific phrases. For example, the writer of narrative 106 has indicated that television “fell apart” (box 120), and extractor 108 might have data indicating that the phrase “fell apart”, when appearing in a television review, is associated with very poor construction quality.

Extractor may comprise, or otherwise make use of, a numerical converter 122. Numerical converter 122 quantifies the sentiment that has been detected in narrative 106, by assigning numbers to that sentiment. In the example of FIG. 1, numerical converter 122 assigns numerical values to three different sentiments. In terms of statistical concepts, each sentiment might be viewed as a variable that takes on the numerical value assigned to a particular sentiment. In the example shown, there are three sentiment variables 124, 126, and 128, which represent the picture sentiment, the sound sentiment, and the construction quality sentiment (labeled P, S, and C, respectively). These variables could represent the sentiment on any sort of numerical scale; in the example of FIG. 1, a scale of one to ten is used. Thus, based on the sentiments concerning the Minisonic television's picture and sound, as expressed in narrative 106, numerical converter 122 might assign values to the variables such as P=9 (outstanding picture quality), S=8 (very good sound quality), and C=1 (exceptionally bad construction quality).

Another type of information that may be analyzed is provider data 104, which is analyzed in order to mine basic facts about the products and/or services that are the subject of reviews. Provider data 104 may be supplied by the provider of a product or service (e.g., the manufacturer of a product). In the example of FIG. 1, provider data 104 contains the manufacturer's suggested retail price (“MSRP”) of a particular Minisonic-brand television (i.e, $1499), and also contains the screen size of the television (i.e., 46 inches). Provider data 104 could contain various other types of information (e.g., the screen resolution, the number of inputs, the power consumption, etc.). However, for purposes of illustration, just the price and screen size are shown in FIG. 1.

Provider data 104 may be analyzed by extractor 130. Extractor 130 may work similarly to extractor 108, but may be configured to extract the type of information that would be contained in a product data sheet rather than the type of information that would be contained in a narrative review. Extractor 130, in this example, determines the values of two variables 132 and 134, which represent the price and diagonal screen size of a television and are labeled R and D, respectively. Thus, extractor 130 might set the variables to the values R=1499 and D=46. In the example of FIG. 1, the values that extractor 130 is extracting are numerical values, and thus a numerical converter is not shown in connection with extractor 130. However, it is noted that extractor 130 could extract non-numeric values, and a numerical converter could be used to convert these values to numbers. For example, if the product being evaluated is a car, then provider data 104 might indicate that the transmission of a car is “automatic” or “manual”. In order to simplify statistical analysis of this data, one might define a transmission variable, T, which takes on the value one (for automatic) or two (for manual).

It is noted that the example in FIG. 1 shows reviews and data concerning a particular product. However, the same technique shown in FIG. 1 and described above could be used with any type of product, or with a service. For example, a travel web site might offer reviews of airlines and car rental services. In the case of an airline, extractor 108 might examine a narrative review to find people's sentiments about the airline's on-time performance, the friendliness of the flight crew, the quality of the in-flight meals, etc. In that example, provider data 104 might contain information about ticket prices, the size of seats in the different cabin classes, terms of the frequent flyer program, etc., and extractor 130 might extract data concerning these features of the airline. In general, the reviews and provider data may relate to any type of product and/or service.

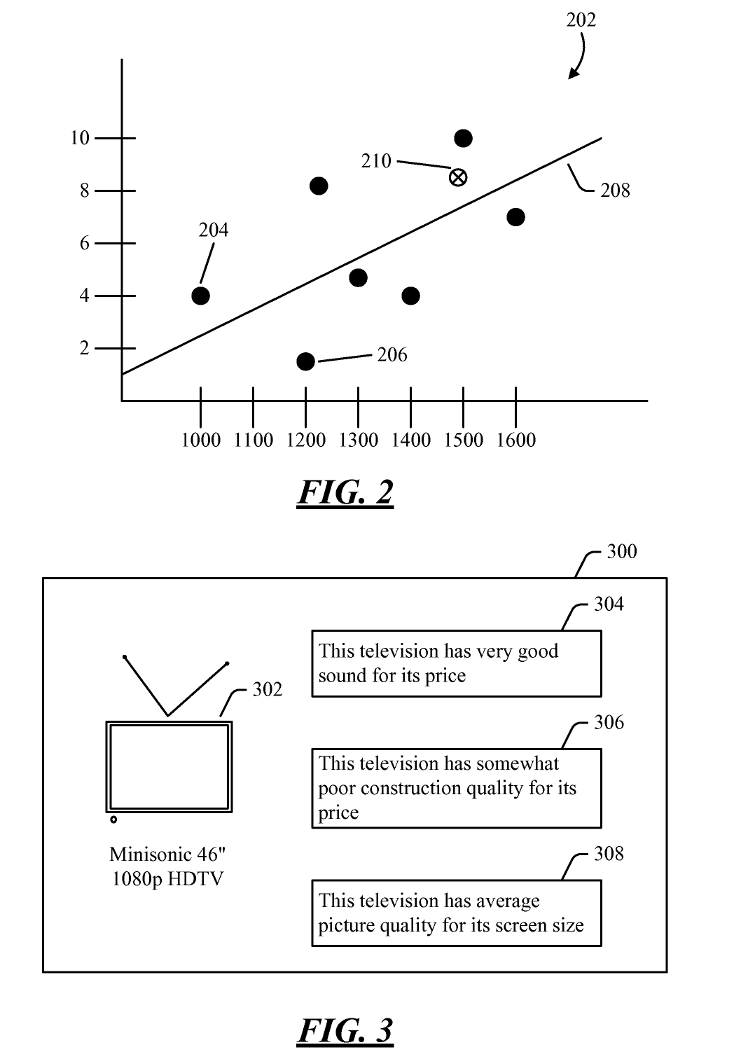

One result of the scenario in FIG. 1 is to assign values to a set of variables. Statistical analysis seeks to find relationships between different variables, and to analyze actual data in view of these relationships. FIG. 2 shows the relationship between two example variables, and an example statistical analysis that may be performed on those variables.

Graph 202 plots the values of the price variable (P) against the sound sentiments variable (S). The example of graph 202 shows seven data points, which may have been collected across various different types of televisions. Typically, there may be hundreds or thousands of data points, but for simplicity of illustration, only seven data points are shown. Each data point (shown with a solid circle) represents a specific review of a specific television. For example, data point 204 indicates that a person reviewed a television that has a $1000 suggested retail price. That person used some words to express his or her sentiment about the sound quality of that television, and that sentiment has been given a numerical value of four on a scale of one to ten (i.e., below average sound quality). The position of data point 204 on graph 202 represents the pair of values (sound sentiment, price) after the extractors and/or numerical converters have mined this information from the underlying data. Similarly, data point 206 indicates that a person reviewed a $1200 television, and that the sentiment expressed about sound quality in that review was assigned the value one on a scale of one to ten (i.e., very poor sound quality). The other data points indicated by solid circles represent the sound quality sentiments for various televisions having various prices.

Given a set of data such as the data points shown in graph 202, it is possible to perform various types of statistical analyses on these data. One such example is shown in FIG. 2, where a regression line 208 is drawn through the data. The regression line represents a probable linear relationship between the S and P variables, indicating that reviewers' sentiments about the sound quality of televisions tend to increase in linear proportion to the price of the television. Finding a linear relationship between two variables is merely one type of analysis that could be performed. As another example, one could create a bar chart that puts all televisions in a given price range (e.g., $1000-1100) in one bin, and indicates the average sound sentiment for all televisions in that price range. Or, one could calculate the average sound sentiment for each brand of television. In effect, regression line 208 represents the average sound sentiment for each price level; such a line can be drawn if the data show a linear relationship between price and sound sentiment. However, in general, any statistic can be calculated for any category of product or services. Of course, the idea of finding relationships between variables is not limited to television reviews. For example, in the case of airline reviews, one could calculate the average sentiment about the friendliness of flight crews on all transpacific flights, on all flights operated by a specific airline, on all flights with ticket prices in the $1000-1500 price range, etc.

Returning to the example of FIG. 2, as noted above a linear relationship is shown between the price of a television and the sentiment that reviewers have expressed about the sound quality of that television. On graph 202, point 210 (marked with a circled X) represents the average sound sentiment that reviewers have expressed about a specific brand and model of television: the Minisonic 46-inch 1080p HDTV. As in the example of FIG. 1, this television has a suggested retail price of $1499 (as indicated by the horizontal position of data point 210 on graph 202). Moreover, data point 210 indicates that the average sentiment that reviewers have expressed about the sound quality of that television corresponds to a nine on a scale of one to ten (as indicated by the vertical position of data point 210). Thus, based on regression line 208, the average sound sentiment for a $1499 television is slightly less than seven, but the average score for the Minisonic is a nine. This disparity between the average sound sentiment for $1499 televisions and the average review of the Minisonic suggests a statement that can be made: The Minisonic television has particularly good sound quality for its price. (The various different brands of 46-inch 1080p HDTV televisions are, in some sense, different versions of the same product, so they can meaningfully be compared with each other.)

Based on analyses such as the one shown in FIG. 2, statements can be made about a product or service, and these statements may be provided to a user. Thus, FIG. 3 shows an example user interface 300 that contains statements about a product or service.

User interface 300 might be the web page of a review web site. The product being reviewed, in this example, is the Minisonic 46-inch 1080p HDTV television. In the example user interface 300, a graphic 302 of the television is shown. Additionally, various statements 304, 306, and 308, concerning the television are shown as part of user interface 300. For example, a web site may collect reviews of televisions, and may provide user interface 300 in order to summarize the reviews.

Concerning the Minisonic 46-inch 1080p HDTV television, statement 304 states that “This television has very good sound for its price.” That statement may be made based on the statistical analysis shown in FIG. 2, since that analysis shows that users have, on average, expressed a very positive sentiment relative to the average or expected sentiment for televisions of the same price.

Statement 306 states that “This television has somewhat poor construction quality for its price.” As described in FIG. 1, at least one reviewer found that the television fell apart very quickly, and this statement by the reviewer was determined, by the information extractor, to indicate that the television is of low construction quality. If several users express that the Minisonic television is of low construction quality, and if their average ratings for the Minisonic are lower than the average ratings of televisions of the same price, then statement 306 is a reasonable description of the information mined from the reviews.

Statement 308 states that “This television has average picture quality for its screen size.” As noted above, any type of category of product or service may be defined. In statements 304 and 306, the price of the television defines the category against which specific televisions are compared. I.e., in statements 304 and 306, the Minisonic television is being compared with other televisions of the same price. However, in statement 308, the Minisonic television is being compared with other televisions that share a particular physical feature (e.g., the same screen size). For example, the average picture sentiment (variable P, in the examples above) might be a six for televisions having a 46-inch screen size, and the Minisonic might also have an average picture rating of six. In that case, statement 308 accurately describes the reviews of the Minisonic relative to other reviews of 46-inch televisions: the average sentiment about the Minisonic's picture quality is the same as the average sentiment about 46-inch televisions overall.

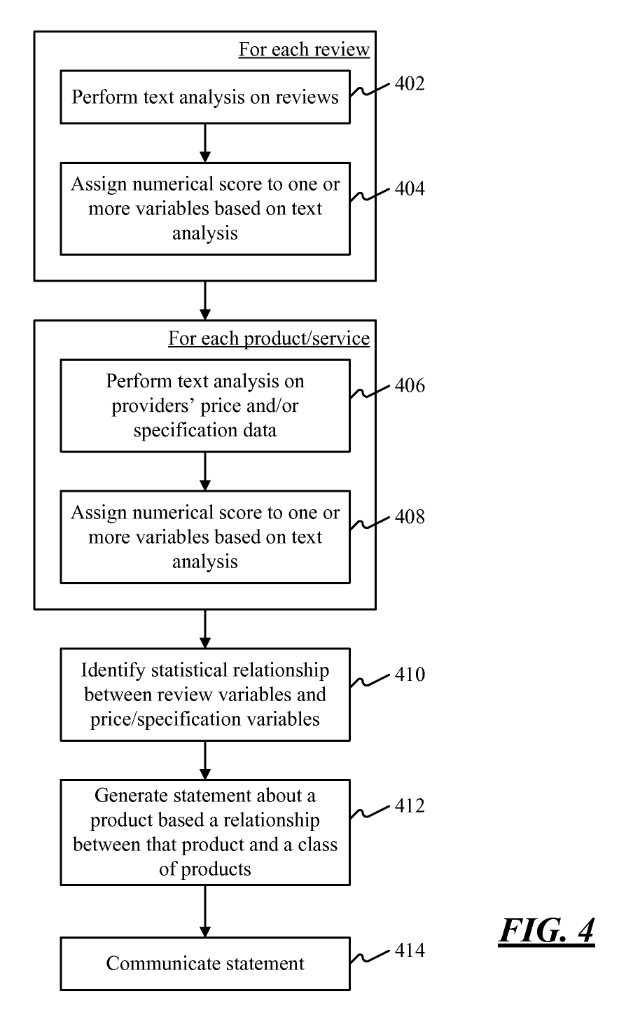

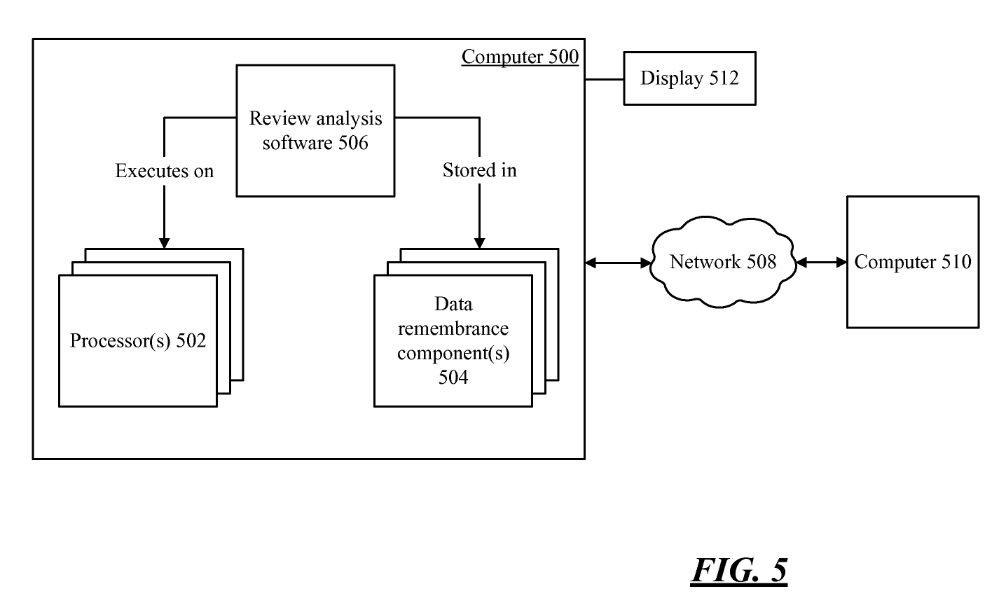

FIG. 4 shows an example process in which reviews may be analyzed, and in which statements about a product or service may be made. Before turning to a description of FIG. 4, it is noted that the flow diagram contained in FIG. 4 is described, by way of example, with reference to components shown in FIGS. 1-3, although the process of FIG. 4 may be carried out in any system and is not limited to the scenarios shown in FIGS. 1-3. Additionally, the flow diagram in FIG. 4 shows an example in which stages of a process are carried out in a particular order, as indicated by the lines connecting the blocks, but the various stages shown in FIG. 4 may be performed in any order, or in any combination or sub-combination.

In the process of FIG. 4, there are one or more reviews to be evaluated, and one or more products and/or services for which provider data exists. Blocks 402 and 404 may be performed for each review, and blocks 406 and 408 may be performed for each piece of provider data.

At 402, a text analysis is performed on a review. For example, the narrative portion of the review may be evaluated to determine what phrases the review uses with respect to attributes of the product. The particular types of words and phrases that the analysis looks for may depend on the product. For example, if the product being reviewed is a television, one may look for words such as “picture,” “sound,” “screen,” “cabinet,” etc., and may look for specific adjectives or phrases near those words (e.g., “crystal clear,” “murky,” “poor,” etc.).

At 404, a numerical score is assigned to one or more variables based on the text analysis. For example, if the product being rated is a television and one variable represents the reviewer's sentiment about the picture quality, then a numerical score may be assigned to represent that sentiment. So, if a user says, “this television has a very good picture,” this verbally-expressed sentiment might be represented by assigning the picture quality variable a value of seven on a scale of one to ten (where “very good” might be a seven, while “outstanding” might be a nine or ten).

The actions performed at 402 and 404 may be performed for each review to be analyzed.

At 406, a text analysis is performed for the provider data associated with each product or service to be evaluated. As described above in connection with FIG. 1, the provider of a product or service may provide a data sheet that indicates various basic items of data (e.g., price and screen size, in the case of a television), and these basic items may be mined from the provider's data. Such mining may occur at 406. Some of the data that are mined may be numbers (e.g., the price of a television), but other pieces of data may be non-numerical and may be converted to numbers at 408. For example, data about a television might include the display technology (e.g., cathode ray, liquid crystal, or plasma), and these different technologies might be assigned numbers such as 1, 2, and 3, to simplify statistical analysis of the data.

At 410, a statistical relationship is identified between one (or more) of the variables derived from reviews and one (or more) of the variables derived from provider data. FIG. 2 and its description provide an example of a statistical relationship that may be determined between two variables. Based on the statistical relationship that is discovered, a statement may be generated about a specific product (at 412). As in the earlier example, if the average sentiment about the sound quality of a $1499 television is seven on a scale of one to ten, but the Minisonic television rates a nine, then a statement can be generated saying that the Minisonic television has very good sound for its price. At 414, this statement may be communicated to a user. For example, the statement may be incorporated into a user interface (such as that shown in FIG. 3), and the user interface may be communicated to a user's computer for display on that computer.

FIG. 5 shows an example environment in which aspects of the subject matter described herein may be deployed.

Computer 500 includes one or more processors 502 and one or more data remembrance components 504. Processor(s) 502 are typically microprocessors, such as those found in a personal desktop or laptop computer, a server, a handheld computer, or another kind of computing device. Data remembrance component(s) 504 are components that are capable of storing data for either the short or long term. Examples of data remembrance component(s) 504 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 500 may comprise, or be associated with, display 512, which may be a cathode ray tube (CRT) monitor, a liquid crystal display (LCD) monitor, or any other type of monitor.

Software may be stored in the data remembrance component(s) 504, and may execute on the one or more processor(s) 502. An example of such software is review analysis software 506, which may implement some or all of the functionality described above in connection with FIGS. 1-4, although any type of software could be used. Software 506 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 5, although the subject matter described herein is not limited to this example.

The subject matter described herein can be implemented as software that is stored in one or more of the data remembrance component(s) 504 and that executes on one or more of the processor(s) 502. As another example, the subject matter can be implemented as instructions that are stored on one or more computer-readable storage media. Tangible media, such as an optical disks or magnetic disks, are examples of storage media. The instructions may exist on non-transitory media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 502) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 500 may be communicatively connected to one or more other devices through network 508. Computer 510, which may be similar in structure to computer 500, is an example of a device that can be connected to computer 500, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more non-transitory computer-readable media that store executable instructions to provide a statement based on reviews, wherein the executable instructions, when executed by a computer, cause the computer to perform acts comprising:
performing a first text analysis on a plurality of reviews of a product or service;
assigning values to one or more first variables based on said first text analysis;
performing a second text analysis on data supplied by providers of said product or service;
assigning values to one or more second variables based on said second text analysis;
identifying a relationship between a third variable and a fourth variable, wherein said third variable is one of said first variables, and wherein said fourth variable is one of said second variables; and
generating a statement concerning a version of said product or service, wherein said statement compares said version of said product or service with other versions of said product or service.

2. The one or more non-transitory computer-readable media of claim 1, wherein said reviews are of a product.

3. The one or more non-transitory computer-readable media of claim 1, wherein said reviews are of a service.

4. The one or more non-transitory computer-readable media of claim 1, wherein said reviews are of a product, and wherein said statement compares a first version of said product with other versions of said product that have the same price as said first version of said product.

5. The one or more non-transitory computer-readable media of claim 1, wherein said reviews are of a product, and wherein said statement compares a first version of said product with other versions of said product that share a physical feature with said first version of said product.

6. The one or more non-transitory computer-readable media of claim 1, wherein said identifying of said relationship comprises:
finding a linear relationship between said third variable and said fourth variable.

7. The one or more non-transitory computer-readable media of claim 1, wherein each of said first variables corresponds to an attribute of said product or service, and wherein said assigning of values to said one or more first variables comprises assigning a numerical value to each of said first variables based on said first text analysis of said reviews.

8. A system for creating a statement concerning a product, the system comprising:
a processor;
a memory; and
an analysis component that is stored in said memory and that executes on said processor, wherein said analysis component performs a first text analysis on a plurality of reviews of a product and a second text analysis on data supplied by providers of said product, assigns values to one or more first variables based on said first text analysis, assigns values to one or more second variables based on said second text analysis, identifies a relationship between a third variable that is one of said first variables and a fourth variable that is one of said second variables, and generates a statement concerning a version of said product, wherein said statement is based on a comparison of a value of said third variable for said version of said product with a value of said third variable derived from information concerning a set of versions of said product, wherein said set of versions of said product comprises both said version of said product and other versions of said product.

9. The system of claim 8, and wherein said statement compares a first version of said product with other versions of said product that have the same price as said first version of said product.

10. The system of claim 8, wherein said statement compares a first version of said product with other versions of said product that share a physical feature with said first version of said product.

11. The system of claim 8, wherein said statement compares said version of said product with other versions of said product.

12. The system of claim 8, wherein said analysis component identifies said relationship by finding a linear relationship between said third variable and said fourth variable.

13. The system of claim 8, wherein each of said first variables corresponds to an attribute of said product or service, and wherein said analysis component assigns values to said one or more first variables by assigning a numerical value to each of said first variables based on said first text analysis of said reviews.

14. The system of claim 8, wherein said analysis component communicates said statement to a user.

15. A method of providing a statement based on reviews, the method comprising:
using a processor to perform acts comprising:
performing a text analysis on a plurality of reviews of a product or service;
assigning values to one or more first variables based on said text analysis;
assigning values to one or more second variables based on data supplied by providers of said product or service;
identifying a relationship between a third variable and a fourth variable, wherein said third variable is one of said first variables, and wherein said fourth variable is one of said second variables; and
generating a statement concerning a first version of said product or service, wherein said statement compares said first version of said product or service with a plurality of versions of said product or service, wherein said plurality of versions includes both said first version and other versions.

16. The method of claim 15, wherein said reviews are of a product.

17. The method of claim 15, wherein said reviews are of a service.

18. The method of claim 15, wherein said reviews are of a product, and wherein said statement compares a first version of said product with other versions of said product that have the same price as said first version of said product.

19. The method of claim 15, wherein said reviews are of a product, and wherein said statement compares a first version of said product with other versions of said product that share a physical feature with said first version of said product.

20. The method of claim 15, wherein each of said first variables corresponds to an attribute of said product or service, and wherein said assigning of values to said one or more first variables comprises assigning a numerical value to each of said first variables based on said text analysis of said reviews.
